(19) United States
(12) Patent Application Publication
(10) Pub. No.: US 2003/0107431 A1
(43) Pub. Date: Jun. 12, 2003

(54) BALANCING GATE-LEAKAGE CURRENT IN DIFFERENTIAL PAIR CIRCUITS

(76) Inventor: Stephen H. Tang, Beaverton, OR (US)

Correspondence Address: FISH & RICHARDSON, PC, 4350 LA JOLLA VILLAGE DRIVE, SUITE 500, SAN DIEGO, CA, 92122, US

(21) Appl. No.: 10/014,009

(22) Filed: Dec. 10, 2001

(51) Int. Cl. G06G 7/12

(52) U.S. Cl. 327/563

(57) ABSTRACT

A differential circuit stage that produces a difference signal from two input signals, and a gain stage which applies a gain to the difference signal, the gain stage having a pair of transistors connected to balance gate-leakage current in the differential stage. A first transistor is connected to the differential stage and the first transistor is sized to provide current to balance the differential stage. A second transistor is connected to the first transistor and the second transistor is sized to eliminate leakage current in the first transistor.

### BACKGROUND

This invention relates to differential pair circuits.

Integrating high-performance microprocessors, which require thin gate oxides, with an analog circuit, such as an operational amplifier or a digital-to-analog or an analog-to-digital converter, lead to higher leakage through the gate oxide due to tunneling currents. Also, thinner gate oxides require lower supply voltages to maintain device reliability.

Gate current leakage of a MOSFET is similar to the base current of a bipolar junction transistor (BJT) in that a DC current enters a control terminal of the transistor. However gate current leakage in a MOSFET is caused by exceeding the oxide tunneling voltage of the MOSFET, which is less the 1 volt, while the BJT breakdown voltage at the collector-base pn-junction is usually much greater than 1 volt. Typical CMOS analog circuits are fabricated using thicker oxides and higher supply voltages than those for cutting-edge CMOS digital circuits.

### DESCRIPTION OF DRAWINGS

FIG. 1 is an operational amplifier circuit.

FIG. 2 is a schematic diagram of an operational amplifier.

### DESCRIPTION

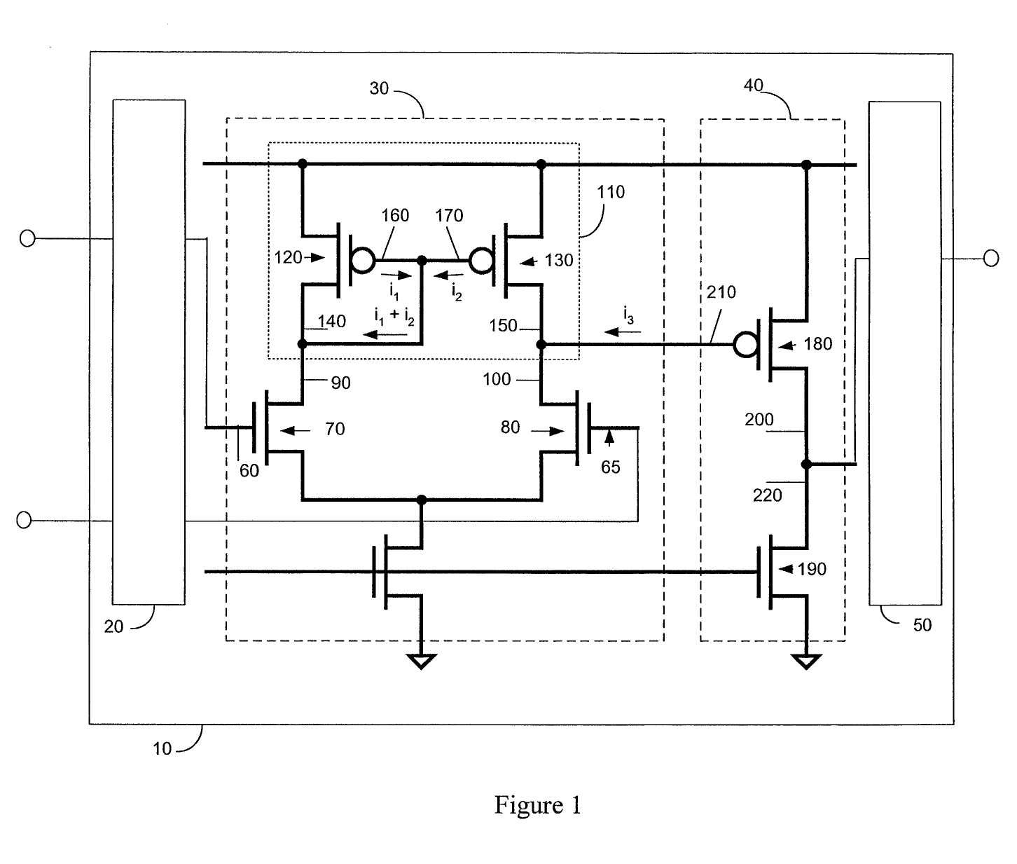

FIG. 1 shows an operational amplifier (op-amp) 10 including MOSFET transistors 120, 130 that introduce leakage current into a differential stage 30. By appropriately sizing MOSFET transistors 180, 190 in a subsequent gain stage 40, the leakage current is compensated. By compensating for the leakage currents, the op-amp 10 will provide maximum signal gain when common signals are received at input stage 20.

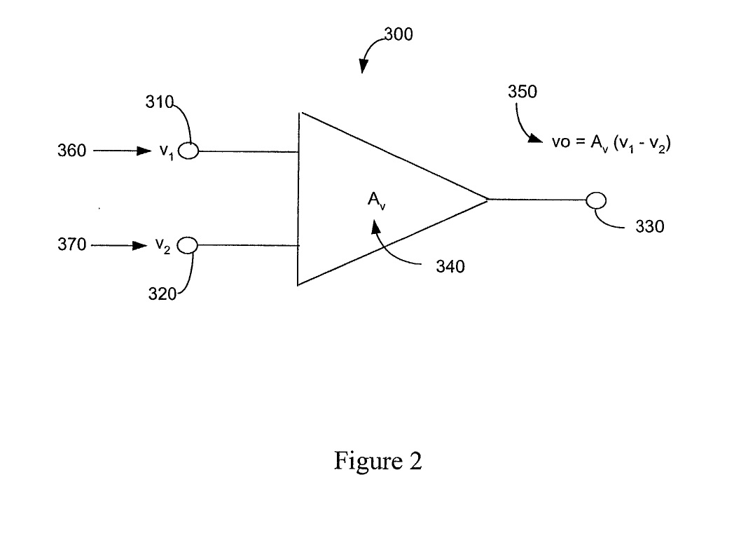

FIG. 2 shows a schematic diagram of an op-amp 300 with typical input leads 310, 320 and output lead 330. Op-amp 300 is a direct-coupled, high gain amplifier of gain Av 340 where an output signal v₀ 350 is the amplified difference of two input signals v₁ 360 and v₂ 370.

Returning to FIG. 1, as is typical for MOSFETs, transistors 120, 130 have gate leads 160, 170 and drain leads 140, 150. A current mirror 110 is formed by connecting gate lead 160 to gate lead 170 and drain lead 140. Tunneling currents generated by decreases in gate oxide thickness cause increased leakage currents i₁, i₂ on gate lead 160 and gate lead 170 which combine. To balance this leakage current, transistor 180 with gate lead 210 is sized to provide a current i₃ equal to the combined leakage currents of the gate leads 160, 170 (i₃=i₁+i₂). A transistor is sized to achieve proper performance by defining the physical dimensions of the features that form the transistor. When transistors 120, 130 are identically fabricated, sizing transistor 180 twice as large as transistor 120 produces current i₃ as twice the leakage current i₁ or equal to the sum of i₁ and i₂. To ensure current compensation by eliminating any gate to drain leakage in transistor 180, transistor 190 with drain lead 220 connects to drain lead 200 of transistor 180. Gate to drain leakage in transistor 180 is eliminated by sizing transistor 190 to ensure the voltage at drain 200 equals the voltage at gate 210 when the same input voltages are received at the input stage 20.

Transistor 70 and transistor 80 have corresponding drain leads 90, 100 that connect to drain leads 140, 150 of transistors 120, 130 in order to propagate input signals received at gates leads 60, 65 from the input stage 20. Drain lead 90, of transistor 70, receives the combined leakage currents i₁ and i₂, mentioned above, which is compensated by introducing current i3 into drain lead 100 of transistor 80. By providing the current compensation to the differential stage 30, an output stage 50, connected to the drain lead 220 of transistor 190, can operate with a maximum output gain when equal signals are received at the input stage 20.

Other embodiments are within the scope of the following claims. For example, this technique can be applied to other op-amp topologies such as the folded-cascode op-amps. The technique could also be used to compensate gate leakage current in other op-amp based circuits such as analog-to-digital converters (A/D), digital-to-analog converters (D/A), linear amplifiers, switched-capacitor filter circuits, and analog comparators.

What is claimed is:

1. An apparatus comprising:
a differential circuit stage which produces a difference signal from two input signals; and
a gain stage which applies a gain to the difference signal, the gain stage having a pair of transistors connected to balance gate-leakage current in the differential stage.

2. The apparatus of claim 1 in which the gain stage comprises:
a first transistor connected to the differential stage, the first transistor sized to provide current to balance the differential stage.

3. The apparatus of claim 2 in which the gain stage comprises a second transistor connected to the first transistor, the second transistor sized to reduce leakage current in the first transistor.

4. The apparatus of claim 1 wherein the differential stage produces a maximum gain when equal signals are received at inputs to the differential stage.

5. The apparatus of claim 2 wherein the first transistor of the gain stage is sized larger than a transistor in the differential stage.

6. The apparatus of claim 2 wherein the first transistor of the gain stage is sized twice as large as a transistor in the differential stage.

7. The apparatus of claim 1 wherein the differential stage includes at least one transistor.

8. The apparatus of claim 7 wherein the at least one transistor comprises a MOSFET.

9. The apparatus of claim 2 wherein the first transistor of the gain stage comprises a MOSFET.

10. The apparatus of claim 3 wherein the second transistor of the gain stage comprises a MOSFET.

11. The apparatus of claim 1 wherein the differential stage and gain stage comprise a portion of an operational amplifier.

12. The apparatus of claim 1 wherein the differential stage and gain stage comprise a portion of one of: an analog to digital converter, a digital to analog converter, a folded-cascode operational amplifier, a linear amplifier, a switched-capacitor filter, or an analog comparator.

13. A method comprising:
connecting two transistors in a differential stage of a circuit, the two transistors being connected to generate current flow during operation of the circuit; and
connecting a gain stage to the differential stage, the gain stage balancing the current flow during operation of the circuit.

14. The method of claim 13 further comprising sizing a first transistor in the gain stage to balance current flow into the differential stage.

15. The method of claim 14 further comprising sizing a second transistor in the gain stage to eliminate leakage current in the first transistor.

16. The method of claim 14 further comprising sizing the first transistor larger than a transistor in the differential stage.

17. The method of claim 14 further comprising sizing the first transistor twice as large as a transistor in the differential stage.

18. The method of claim 13 further comprising connecting two MOSFETs as the two transistors.

19. The method of claim 14 further comprising connecting a MOSFET as the first transistor.

20. The method of claim 15 further comprising connecting a MOSFET as the second transistor.

21. The method of claim 13 further comprising connecting the differential stage and the gain stage to comprise a portion of an operational amplifier.

22. The method of claim 13 further comprising connecting the differential stage and the gain stage to comprise a portion of one of: an analog to digital converter, a digital to analog converter, a folded-cascode operational amplifier, a linear amplifier, a switched-capacitor filter, or an analog comparator.

23. A method comprising:
using a gain stage to compensate a differential stage generating a leakage current, the differential stage comprising two transistors.

24. The method of claim 23 further comprising compensating the differential stage using two sized MOSFETs.

25. The method of claim 23 further comprising using a gain stage comprising two transistors.

26. An operational amplifier comprising:
an input stage with two inputs for connection to external circuitry;
a differential stage connected to the input stage, the differential stage generating a difference signal from two signals at the two inputs of the input stage, the differential stage including two transistors with respective gate leads connected;
a gain stage connected to the differential stage, the gain stage amplifying the difference signal, the gain stage including two transistors, the first transistor being connected to the differential stage and sized to compensate for the leakage current at the gate leads of the two transistors of the differential stage, the second transistor being connected to the first transistor and sized to eliminate leakage current on the first transistor; and
an output stage connected to the gain stage, the output stage receiving the amplified difference signal from the gain stage, the output stage including an output lead that transfers the amplified difference signal to external circuitry.

27. The operational amplifier of claim 26 wherein the transistors are MOSFETs.
